(19) United States
(12) Patent Application Publication
(10) Pub. No.: US 2014/0256849 A1
(43) Pub. Date: Sep. 11, 2014

(54) SILICATE ENCLOSED PIGMENT PARTICLES

(71) Applicant: PPG INDUSTRIES OHIO, INC., Cleveland, OH (US)

(72) Inventors: Noel R. Vanier, Wexford, PA (US); John Donnelly, Monroeville, PA (US); Joseph T. Valko, Pittsburgh, PA (US)

(73) Assignee: PPG Industries Ohio, Inc., Cleveland, OH (US)

(21) Appl. No.: 13/793,124

(22) Filed: Mar. 11, 2013

(51) Int. Cl. C08K 7/26

(52) U.S. Cl. CPC C08K 7/26
USPC 523/218; 106/409

(57) ABSTRACT

Disclosed is a silicate-enclosed pigment composition comprising hollow silicate shells each defining a core and pigment particles received in the cores. Silicate-enclosed pigments may be produced by dispersing pigment particles in an aqueous solution of an alkali silicate and spray drying the dispersion to yield a plurality of silicate shells each defining a hollow core, wherein the pigment particles are received within the hollow cores.

### FIELD OF THE INVENTION

The present invention relates to pigment particles enclosed in silicate shells and methods of producing the same. More specifically, the pigment particles are received within the cores of silicate shells.

### BACKGROUND OF THE INVENTION

Synthetic micron-sized hollow spheres have been used as low-density fillers for polymer systems such as plastics. Such hollow spheres may be prepared by spray drying a solution of film-forming material, which may be organic or inorganic, in a volatile solvent with a blowing agent. The hollow spheres may also be prepared to contain particulate matter, by dispersing the particulate matter in the solution of film-forming material. Upon spray drying, the particulate matter becomes incorporated into the walls of the hollow spheres.

The particulate matter may include inorganic components that provide pigmentation to the hollow spheres, such as metal oxides. To ensure proper formation of the hollow spheres, the particulate matter is selected so that it does not react with or dissolve in the components of the solution of film-forming material.

### SUMMARY OF THE INVENTION

The present invention is directed to a silicate-enclosed pigment composition comprising hollow silicate shells each defining a core and pigment particles received in the cores. Silicate-enclosed pigments may be produced by dispersing pigment particles in an aqueous solution of an alkali silicate and spray drying the dispersion to yield a plurality of silicate shells each defining a hollow core, wherein the pigment particles are received within the hollow cores.

### BRIEF DESCRIPTION OF THE DRAWINGS

FIG. 1 includes photographs of coating compositions containing (i) spray dried particles of the prior art, (ii) sprayed dried particles of the present invention and (iii) TiO₂ particles;

FIG. 2 is a transmission electron microscope (TEM) image of prior art particles; and

FIG. 3 is a TEM image of particles produced according to one embodiment of the present invention.

### DETAILED DESCRIPTION OF THE INVENTION

For purposes of the following detailed description, it is to be understood that the invention may assume various alternative variations and step sequences, except where expressly specified to the contrary. Moreover, other than in any operating examples, or where otherwise indicated, all numbers expressing, for example, moieties in a general chemical formula and quantities of ingredients used in the specification and claims are to be understood as being modified in all instances by the term “about”. Accordingly, unless indicated to the contrary, the numerical parameters set forth in the following specification and attached claims are approximations that may vary depending upon the desired properties sought to be obtained by the present invention. At the very least, and not as an attempt to limit the application of the doctrine of equivalents to the scope of the claims, each numerical parameter should at least be construed in light of the number of reported significant digits and by applying ordinary rounding techniques.

Notwithstanding that the numerical ranges and parameters setting forth the broad scope of the invention are approximations, the numerical values set forth in the specific examples are reported as precisely as possible. Any numerical value, however, inherently contains certain errors necessarily resulting from the standard variation found in their respective testing measurements.

Also, it should be understood that any numerical range recited herein is intended to include all sub-ranges subsumed therein. For example, a range of “1 to 10” is intended to include all sub-ranges between (and including) the recited minimum value of 1 and the recited maximum value of 10, that is, having a minimum value equal to or greater than 1 and a maximum value of equal to or less than 10.

In this application, the use of the singular includes the plural and plural encompasses singular, unless specifically stated otherwise. In addition, in this application, the use of “or” means “and/or” unless specifically stated otherwise, even though “and/or” may be explicitly used in certain instances.

The silicate-enclosed pigment composition of the present invention includes pigment particles that are received in the core of hollow silicate shells. The pigment particles may be metal oxides, such as titanium dioxide, iron oxide, chromium III oxide, zinc oxide, antimony trioxide, and zirconium dioxide, organic pigments, particularly organic basic pigments that complex well by polyacrylic acid, as described below. By hollow, it is meant the silicate shells each define a core region in which other material, generally air, is received. The silicate-enclosed pigment composition is particularly suited for imparting substrate hiding and/or color (including white) to a coating composition. In one embodiment, the pigment particles are at least partially adhered to inner surfaces of the hollow shells. Moreover, in contrast to prior silicate shells containing pigments, the pigment particles in the present invention are absent from the shells. By absent, it is meant that the pigment particles, if present at all in a de minimus amount in the shell, do not materially alter the properties of the shell. As compared to silicate shells that contain pigments, the pigments in the cores of the silicate-enclosed pigment composition of the present invention are at least partially surrounded by the air within the cores. The resulting refractive index (RI) contrast between air and the pigment particles is enhanced compared to the RI contrast between pigment and its surroundings in prior silicate shells that contain pigments. As such, a coating composition containing the silicate-enclosed pigment composition of the present invention efficiently scatters light and when coated onto a substrate, provides high hiding of the substrate.

In the present invention, the pigment particles may be located within the cores of the hollow silicate shells by at least partially encapsulating each of the pigment particles in a pigment shell, such as a polymer shell. The pigment shell minimizes or prevents the pigment particles from becoming entrapped in the silicate shells. In one embodiment, for pigment particles comprising TiO₂, the surfaces of the TiO₂ particles are complexed with a polyacrylic acid to at least partially encapsulate the TiO₂ particles with the polyacrylic acid. Suitable examples of polyacrylic acid and/or precursors thereof include polymethacrylic acid and copolymers thereof having at least 10 wt. % of acrylic acid and/or methacrylic acid functional groups. In a basic aqueous environment, the polyacrylic acid forms an aqueous acrylic gel that at least partially encapsulates each TiO₂ particle. Upon drying, such as spray drying the silicate shells as described below, the water in the acrylic gel is removed, whereby the TiO₂ particles are at least partially encapsulated by an acrylic polymer, which then adheres to the inner surfaces of the silicate shells.

By way of example, a silicate-enclosed TiO₂ composition may be produced by dispersing TiO₂ into water and adding a polyacrylic acid thereto. The TiO₂ dispersion may contain 5 to 50 wt. % TiO₂ and 4 to 40 wt. % polyacrylic acid. The TiO₂ dispersion is stabilized by the addition of a base such as ammonium hydroxide, tetraalkyl ammonium hydroxide, sodium hydroxide, potassium hydroxide or other alkali metal hydroxides, as well as low molecular weight amines having a carbon to nitrogen ratio of less than 4. Addition of the base results in an aqueous acrylic gel containing TiO₂ particles. The aqueous acrylic gel containing TiO₂ particles is mixed with an aqueous solution of sodium silicate and a blowing agent, and the mixture is spray dried, yielding silicate shells having TiO₂ particles at least partially encapsulated within acrylic polymer that are adhered to interior surfaces of the silicate shells.

Any conventional spray drying equipment can be used to implement the process of the invention. The suspension can be atomized into a spray tower by either an atomized wheel or a spray nozzle at temperatures of 150 to 350° C. and outlet temperatures of 60 to 250° C. In particular, silicate shells having acrylic gel encapsulated TiO₂ particles can be prepared by spray drying the material at an inlet temperature of 180 to 300° C. and an outlet temperature of 90 to 180° C. In general, substantially spherical shells are produced from such substances by forming a solution of the silicate in a volatile solvent, adding a mixture of TiO₂ and polyacrylic acid and spray drying the combined solution with the TiO₂/polyacrylic acid mixture under conditions that lead to the production of hollow silicate shells with TiO₂ particles received within the core of the hollow shells. A substance that breaks down to provide a gas in the interior of the particle may be required with certain systems to maintain the expansion of the product while it is still plastic and to prevent breakage under atmospheric pressure when the walls have set. Examples of useful blowing agents include inorganic and organic salts of carbonates, nitrites, carbamates, oxalates, formates, benzoates, sulfites and bicarbonates such as sodium bicarbonate, ammonium carbonate, magnesium oxalate, etc. Other organic substances are also useful such as p-hydroxy phenylazide, di-N-nitropiperazines, polymethylene nitrosamines and many others. Suitable blowing agents include ammonium hydroxide, ammonium carbonate, ammonium pentaborate, C₁-C₄ alcohols (such as methanol), methylamine, dimethylamine, trimethylamine, ethylamine, diethylamine, acetone, methyl acetate and/or dimethyl ether. The product recovered from the spray dryer may be ready for use, or it may require an additional drying step. The spray-dried product may contain 20% water. This water content may then be reduced to 7% or less by heating the particles to temperatures between 70° C. and 300° C.

The silicate enclosed pigment particles are generally spherical having particle sizes of up to 10 microns. Silicate shells containing TiO₂ particles in the cores thereof are desirable for use in imparting hiding to coating compositions, while silicate shells containing colored pigments can be used to impart colors to coating compositions, such as architectural coatings.

The following Examples are presented to demonstrate the general principles of the invention. All amounts listed are described in parts by weight, unless otherwise indicated. The invention should not be considered as limited to the specific Examples presented.

### EXAMPLES

### Comparative Example

A 23% ammonium pentaborate solution was prepared (30 g in 100 g deionized (DI) water) by heating on a hot plate until solution was complete. A portion of this warm solution (56 g) was added to 163.2 g of PQ D sodium silicate solution (PQ Corporation) with mechanical mixing. The viscosity was high and some solids were observed in the solution, so 30 g of DI was added. All of the solids were dissolved after 20 minutes. To this solution was added 21 g of a pigmentary TiO₂ slurry (76% solids) with mechanical mixing. This dispersion was spray dried on a Buchi 290 spray dryer using 200° C. inlet and 100° C. outlet temperatures at −50 mbar, and 65 g of the white product powder was collected.

### Example 1

To 21 g of a pigmentary TiO₂ slurry (76% solids) was added 16 g of polyacrylic acid (63% solids, Acros product code 184992500, MW 2000) and 30 g DI water. Ammonium hydroxide (43.4 g of 28%) was added with mixing, bringing the pH to 11.0. Ammonium pentaborate hydrate (23 g of 23%) was then added. This dispersion was then added by pipette to 163.2 g of PQ D sodium silicate solution and rinsed with 20 g of DI water. The dispersion was spray dried (as in the Comparative Example) except that the outlet temperature was 85° C.

The spray dried powders of the Comparative Example and Example 1 were each dried further in an oven for 1 hour at 110° C. The dried powders were each dispersed in RHOPLEX® SG-30 latex (an architectural latex system from Dow Chemical Co.). The dispersions of spray dried particles were drawn down on a BY opacity chart to make a coating and then dried at room temperature. A control drawdown at the same concentration of TiO₂ was prepared for comparison. As shown in FIG. 1 (Comparative Example (left), Example 1 (middle) and control (right)), a latex coating containing the silicate-enclosed TiO₂ particles of the present invention exhibited improved hiding over silicate shells containing TiO₂ but not containing polyacrylic acid and comparable hiding to a drawdown of TiO₂ itself.

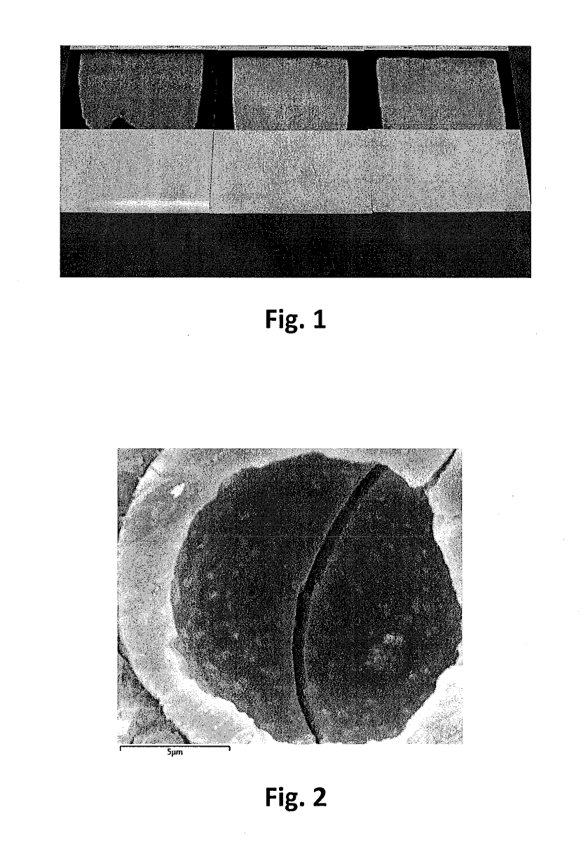

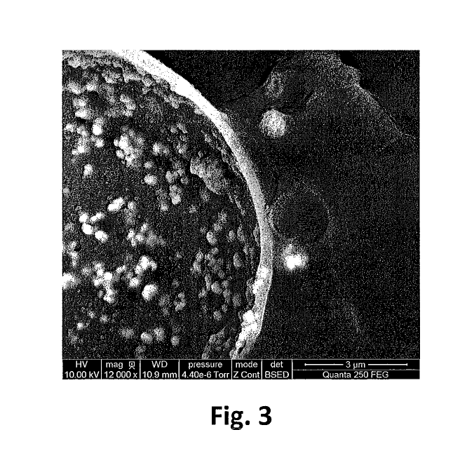

Transmission electron microscope images of cross sections of the particles from the Comparative Example showed that the TiO₂ particles were largely embedded in the silicate shells of the hollow particles produced by spray drying (FIG. 2), with portions of some particles protruding from the shell into the interior. In Example 1, the TiO₂ particles were mostly exposed and hanging off the interior of the silicate shells (FIG. 3). The average refractive index environment of the TiO₂ particles in Example 1 should therefore be lower than that of the Comparative Example (more air contribution) and hence light scattering should be more efficient in Example 1, as demonstrated in FIG. 1.

Whereas particular embodiments of this invention have been described above for purposes of illustration, it will be evident to those skilled in the art that numerous variations of the details of the present invention may be made without departing from the invention as defined in the appended claims.

1. A silicate-enclosed pigment composition comprising:
hollow silicate shells each defining an air-filled core; and
pigment particles received in said air-filled cores.

2. The pigment composition of claim 1, wherein at least some of said pigment particles are adhered to inner surfaces of said hollow shells.

3. The pigment composition of claim 1, wherein said pigment particles are each at least partially enclosed in acrylic shells.

4. The pigment composition of claim 1, wherein said pigment particles comprise TiO2.

5. The pigment composition of claim 1, wherein said pigment particles are not present in said shell.

6. A coating composition comprising the pigment composition of claim 1.

7. A method of making silicate-enclosed pigments comprising:
dispersing pigment particles in an aqueous solution of an alkali silicate; and
spray drying the dispersion to yield a plurality of silicate shells each defining an air-filled hollow core, wherein the pigment particles are received within the air-filled hollow cores.

8. The method of claim 7, wherein the dispersed pigment particles are at least partially enclosed within an acrylic composition.

9. The method of claim 8, wherein the acrylic composition comprises residues of poly(meth)acrylic acid.

10. The method of claim 9, wherein the residues of poly(meth)acrylic acid are provided in a hydrated gel.

11. The method of claim 10, wherein the pigment particles in the hollow cores are at least partially encapsulated by a dehydrated acrylic gel.

12. The method of claim 7, wherein the pigment particles comprise TiO2.

13. A pigment composition comprising silicate-enclosed pigments produced according to the method of claim 7.

14. A coating composition comprising the pigment composition of claim 13.
